(19) United States
(12) Patent Application Publication
(10) Pub. No.: US 2008/0010149 A1
(43) Pub. Date: Jan. 10, 2008

(54) Method of advertising products and services by machine-readable medium and target distribution

(76) Inventor: Hasan Alchaddad, Blainville (CA)

Correspondence Address: OGILVY RENAULT LLP, 1981 MCGILL COLLEGE AVENUE, SUITE 1600, MONTREAL, QC, H3A2Y3, US

(21) Appl. No.: 11/520,592

(22) Filed: Sep. 14, 2006

(30) Foreign Application Priority Data
Jun. 14, 2006 (CA) 2,550,354

(51) Int. Cl. G06Q 30/00

(52) U.S. Cl. 705/14

(57) ABSTRACT

A method of advertising products and services of advertisers located in a targeted geographical area delineated by a postal code region and without the use of paper advertising material is described. The advertising material is registered in a machine readable medium such as a CD/DVD disc in a predetermined navigational format which includes main and sub categories. A personalized printed code is provided on a carrier package containing the CD/DVD disc and is associated with the recipient. A further printed code is provided in a predetermined location of the advertising material and if matched with the personalized printed code provides a benefit to the recipient. The CD/DVD disc also contains non-advertising material for the benefit of the recipient. The carrier package with the CD/DVD disc is delivered to residents of one or more postal code areas by the postal services and these CD/DVD discs are revised and delivered on a periodic basis.

### TECHNICAL FIELD

The present invention relates to a method of advertising products and services of advertisers to potential clientele located in a targeted geographical area delineated by a postal code region and without the use of paper advertising material.

### BACKGROUND ART

It is a well established practice to provide to the public printed advertising material in the form of discounts or coupons for products and services of advertisers, by mailing these in envelopes to a targeted clientele or by providing this material in a plastic bag which is usually accessible at postal box areas. A disadvantage of this form of advertising is that it pollutes the environment when this material is discarded in a non-recycling manner. Also, this printed material occupies large spaces in postal boxes, and when the material is provided in plastic bags at designated areas, very few people will avail themselves of such bags with the advertisement in them. Also, these bags are exposed to the environment and are subject to deterioration by inclement weather conditions and this adds to the pollution of the immediate environment. This form of advertising using bags distribution is also not targeted to specific recipients.

Another disadvantage of the bag distribution system is that the promotional material offered by the advertisers may take a long period of time to reach a targeted customer and therefore there is no assurance that the delivery will be made or made on time, and the timing may be crucial to an advertiser promotion. Also, some of these bags are delivered in batches at mail box locations in lobbies of apartment buildings and are not picked up by all residents.

A still further disadvantage is that often these bags contain too much material adding to the weight of the bag and often these bags easily tear off their supports and pollute the environment. We often see this at the bag dispatch locations.

A still further disadvantage of these prior art forms of distribution is that it results in a waste of paper and to some recipients the image of the advertisers is tarnished due to this waste of paper product which is generated by trees in our forests which are becoming depleted. The cost of producing printed advertising material is also much more when considered with providing advertising material on a machine readable medium, such as a CD, DVD, etc. The advertiser is also limited to a certain space on which he can print material and a printed medium does not provide to a viewer any action or voice advertisement and cannot provide interaction between the advertiser and the recipient. Further, often the printed material is of poor quality and this reflects on the advertiser's quality service and product being offered. Published advertising material is now becoming considered “old fashion” and quickly discarded by the recipients, often without even viewing the material.

A further disadvantage of printed advertising material is that some of this material is often provided with many pages having several advertisements and artwork on each page and it is time-consuming for a user to locate a particular interesting product and this often frustrates the targeted consumer user person. Such material is also not visually attractive and too much advertising material of too many categories is distributed to a consumer at the same time thus causing confusion and disinteresting the consumer from viewing all of this advertising material which eventually finds itself in trashcans.

### SUMMARY OF INVENTION

It is a feature of the present invention to provide a method of advertising products and services of advertisers which substantially overcome the above-mentioned disadvantages of the prior art.

Another feature of the present invention is to provide a method of advertising products and services of advertisers located in a targeted geographical area delineated by a postal code region and without the use of paper advertising material.

Another feature of the present invention is to provide a method of advertising products and services of advertisers using a machine readable CD/DVD medium carrier having a predetermined navigational format configured therein.

Another feature of the present invention is to provide a method of advertising products and services of advertisers using a machine readable CD/DVD medium carrier which also comprises non-advertising material for the benefit of the recipient.

Another feature of the present invention is to provide a method of advertising products and services of advertisers on a machine readable CD/DVD medium carrier which is delivered by the postal services in a specific carrier package and wherein the carrier package is provided with a personalized printed code relating to a benefit to the recipient if matched to a further printed code accessible in a predetermined location of the advertising material configured in the CD/DVD.

Another feature of the present invention is to provide a method of advertising products and services of advertisers in a machine readable CD/DVD medium carrier and wherein the CD/DVD can be returned by the postal service for recycling or safe disposal.

Another feature of the present invention is to provide a method of advertising products and services of advertisers using a medium readable CD/DVD medium carrier and wherein there is associated with the method a foundation which contributes a monetary value to replenish greenery in urban spaces.

According to another feature of the present invention there is provided a method of advertising products and services of advertisers located in a predetermined geographical area through a media database accessible through an internet connection.

According to the above features, from a broad aspect, the present invention provides a method of advertising products and services of advertisers located in a targeted geographical area delineated by a postal code region and without the use of paper advertising material. The method comprises the steps of providing a machine readable medium carrier with advertising material registered therein in a predetermined navigational format. The format includes main advertising categories and sub-advertising categories. A carrier package is produced for the medium carrier and has a personalized printed code on an outer surface thereof for a recipient of the carrier package. The CD/DVD medium carrier is also provided with non-advertising material for the benefit of the recipient and includes a further printed code accessible in a predetermined location of the advertising material and if matched with the personalized printed code on the carrier package, provides a benefit to the recipient. The carrier package with the medium carrier is delivered to residents of one or more postal code areas by the postal service. Additional revised medium carriers are delivered on a periodic basis.

According to a further broad aspect of the present invention there is provided a method of advertising products and services of advertisers located in a predetermined geographical area and without the use of paper advertising material. The method comprises the steps of producing a media database having advertising material formatted therein in a predetermined navigational sequence. The formatted material includes main advertising categories and sub-advertising categories. The media database has incorporated therein a first personalized displayable code for a user accessing the media database. The media database also has non-advertising material for the benefit of the user. The media database also includes a second personalized displayable code accessible at a predetermined location in the advertising material and if matched with the first personalized displayable code, provides a benefit to the user. The user is also provided revised versions of the media database on a periodic basis.

According to a further broad aspect of the present invention the media database is accessible through an internet connection.

### BRIEF DESCRIPTION OF DRAWINGS

A preferred embodiment of the present invention will now be described with reference to the accompanying drawings in which:

FIG. 1A is a plan view of a machine readable CD/DVD medium carrier in which is registered the method of the present invention;

FIG. 1B is a front side view of a carrier package for the CD/DVD as shown in FIG. 1A to be delivered to recipients by the postal service;

FIG. 1C is a rear view of FIG. 1B;

FIG. 2 is a block diagram showing the business method of the present invention;

FIG. 3 is a perspective view of a prior art method of distributing printed advertising material in bags which are located outdoors in a bag holder;

FIG. 4 is a screen representation of an animation associated with the benefit provided to the recipient;

FIG. 5 is a screen representation of a main advertising category;

FIG. 6 is a screen representation of a sub-advertising category;

FIG. 7 is a screen representation of a sub-category of the screen display of FIG. 6;

FIGS. 8 and 9 are screen representations of different main advertising categories;

FIG. 10 is a block diagram illustrating the method of advertising products and services of advertisers through an internet connection where a media database of such method is provided; and

FIG. 11 is a front view of a different type of a carrier package for the CD/DVD which is packaged with a magazine in a film pack.

### DESCRIPTION OF PREFERRED EMBODIMENTS

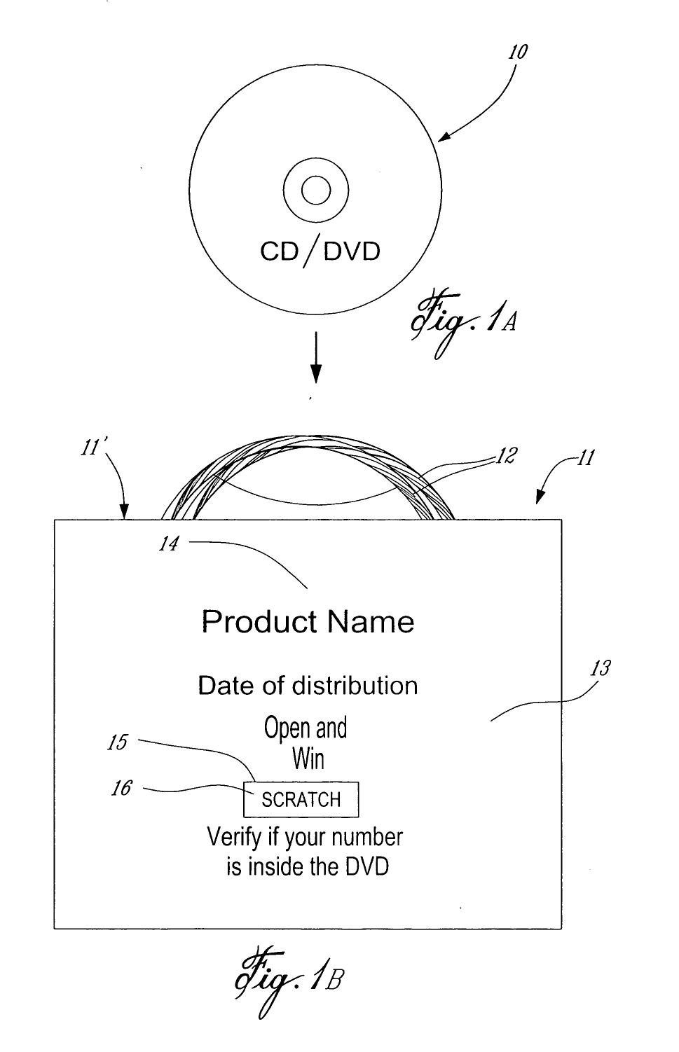

Referring now to the drawings, and more particularly to FIGS. 1A to 1C, there is shown generally at 10 in FIG. 1A, a CD or a DVD disc in which the method of advertising products and services of advertisers has been registered and formatted. The method also comprises the production of a carrier package which is herein represented by reference numeral 11 and which is in the form of an envelope formed in the shape of a small shopping bag having a bag section 11′ suitable for the packaging of the disc 10. This package has retainer means (not shown) to prevent the disc from escaping the package once delivered to the postal service. Handle threads 12 are provided to simulate a shopping bag wherein the shopping bag is representative of the contents provided by the CD or DVD permitting one to view publicity material from a variety of advertisers as well as other entertaining or information material.

The front panel 13 of the carrier package 11 is provided with printed material at 14 which may contain all sorts of logos, slogans, or the logo of a main advertiser. A scratch patch 15 also conceals a code or word 16 thereunder for the recipient to view and compare with a further code concealed in the disc advertising bags. On the reverse side 13′ of the carrier package 11, there is provided printed matter including a return address for the carrier package together with a used disc 10 for recycling the disc and specific information relating to benefits, such as prizes to be won, etc. Also printed on this surface or the front panel surface is the name of the provider together with a description of a foundation controlled by the provider and dealing with the contribution of a monetary value in the form of plants to enhance the environment by effecting plantations. This gesture of the foundation is representative of the green space which is spared by the non-use of paper material to distribute advertisements.

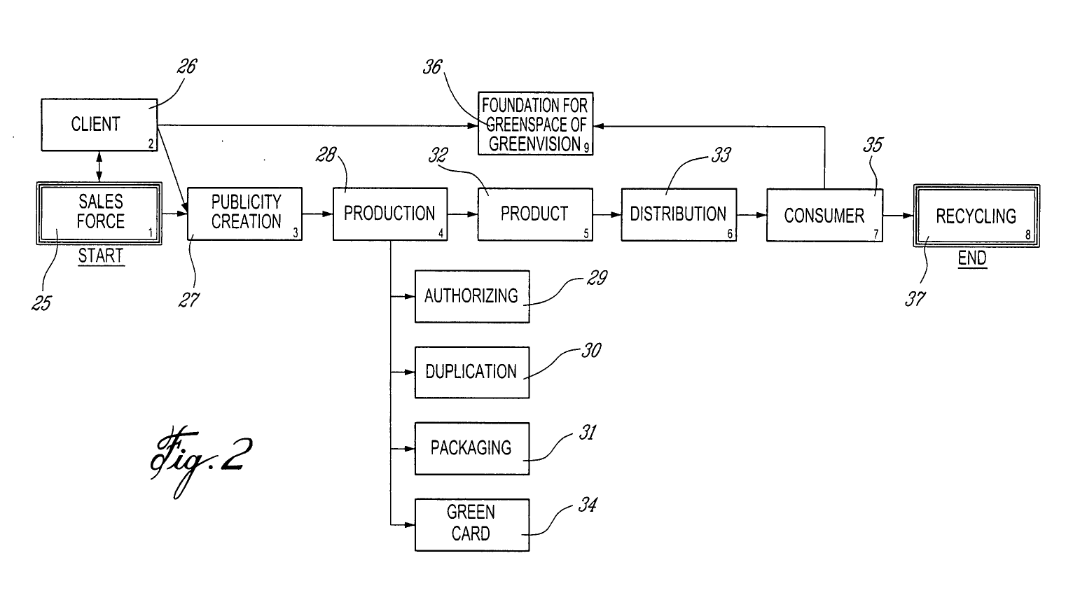

FIG. 3 is an illustration of a prior art method of distributing advertising material. As shown in FIG. 3, a plurality of plastic bags 17 containing printed advertising material 18 therein is supported on wicket pins 19 in a sheltered cover 20 which is open to the front and sides permit access to these bags. As can be seen, these bags are open to inclement weather conditions although there is a top wall on the support. These distributors often can only hold a very small limited amount of these bags due to the size of the bags and therefore these distributors must be replenished on frequent periodic basis adding to the cost of its distribution. Because they can accommodate very few bags often we find these distributors empty. This prior art method has been discussed in the preamble portion of the specification and this figure is provided for illustrating that prior art concept.

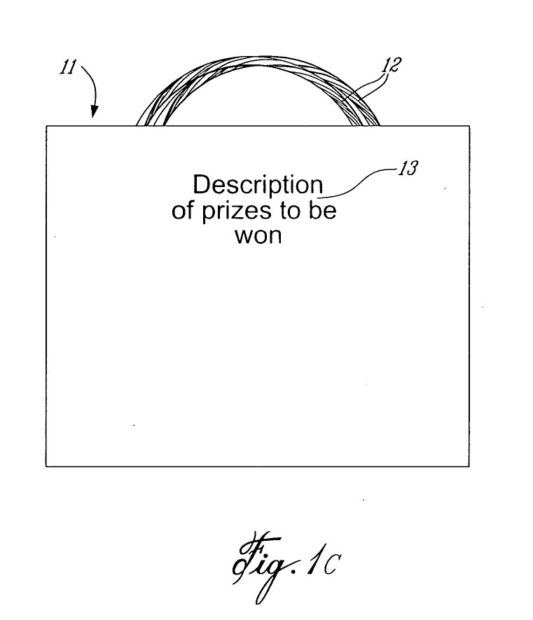

Referring now to FIG. 2, there is shown the business method associated with the advertising product, its packaging and distribution as described herein. This block diagram has several blocks which represent different steps or entities or products in the business method. As hereinshown, the provider 25 solicits a plurality of clients 26 interested in advertising their services or products through the distribution of a CD/DVD medium carrier. The client is visited by the provider's representative and informed of the various advantages of the present method and the fact that it can target consumers in a specific geographical area by postal codes and its method of grasping the attention of the potential consumer.

The client then jointly with the provider develops publicity material which is to be registered and formatted in the disc and this is representative by block 27. Preferably, but not exclusively, the client offers products or services within a specific targeted postal code area of the distribution of the disc. The client 26 is either a regional, semi-regional or local business entity.

The CD/DVD medium carrier is delivered by the post office on a periodic basis such as every two weeks and the formatted material is such as to entice the recipient, i.e., the potential customer of the advertisers to visualize its content. Accordingly, there is provided the personalized printed code on the front panel 13 of the carrier package to induce the recipient to visualize the CD or DVD in his computer or DVD player, where a further printed code is provided in the formatted material at a predetermined location in the advertising material. The user needs to visualize at least some of the material in the disc to compare the further code with his personalized printed code on the front panel to see if he has won a prize. The user navigates through the material by the use of his remote controller or keyboard, mouse, external pointing device, etc.

Referring again to FIG. 2, a CD or DVD master is produced at step 28 and then is authored in a further step 29 reproduced in quantity at step 30 and packaged at step 31. The final product is representative by step 32 ready for shipping to the postal services for distribution at step 33 by the postal service.

A further step is foreseen and representative by block 34 wherein a magnetic card, referred to as a green card for the advertisement of conservation, may be placed into the carrier package together with the disc and this green card may be used by the recipient at any of the advertisers retail locations wherein the user can accumulate dollars based on his purchases and for further use in purchasing material.

Block 35 is representative of the recipient who has become aware of the foundation 36 created by the provider 25 and his clients who contribute to replenish the green environment. The consumer also has the option of returning the disc after it has no more use to him and this is done by securing it in the carrier package 11 and placing the carrier in a mailbox for delivery by the postal services back to the provider 25 or a designated recycling recipient, and this is representative by step 37. Alternatively, the CD/DVD may contain a return address and stamp and mailed back to the postal service.

One can appreciate that on a CD or DVD medium carrier a very large content can be delivered to a consumer. The medium carrier of the present invention is formatted in such a way as to educate the consumer by providing a new method of accessing promotional material by the classification of such material in an easy to navigate method by the use of hand-operable controllers, such as remote control, mouse, keyboard, external pointing device, etc.

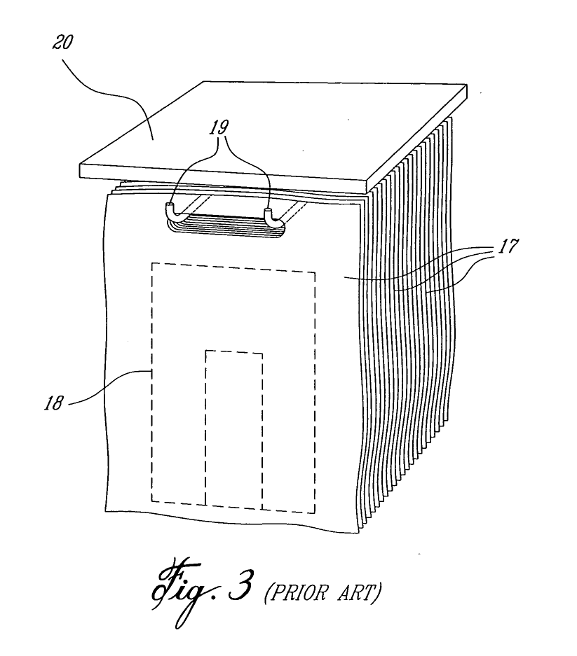

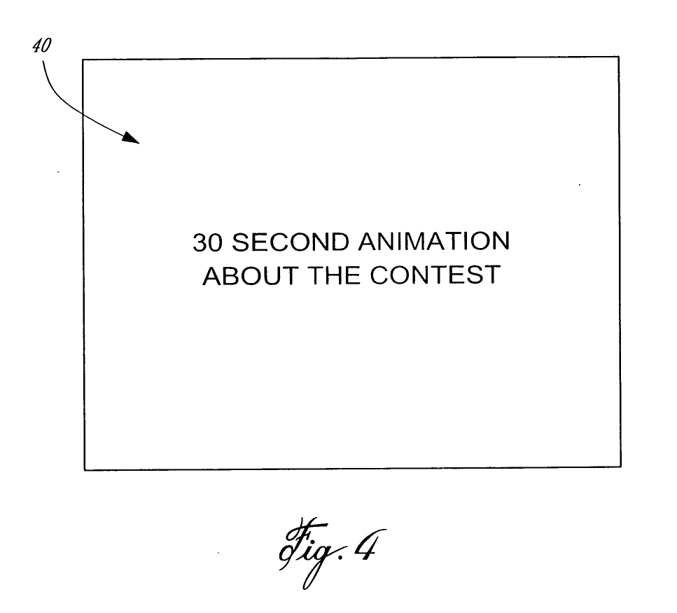

The manner in which this advertising material is packaged will now be described with reference to FIGS. 4 to 7. First, when the DVD is projected on the screen of the computer or the television screen associated with a DVD player, a short animation is displayed on the screen. This animation lasts no more than 60 seconds and provides a brief explanation to the user how to navigate through the material formatted into the CD or DVD. It also informs the viewer as to where to find the second printed code to see if he or she has won a prize. After this short presentation, the image changes to one as shown in FIG. 5. The image in FIG. 5 consists of a representation of a plurality of main advertising categories 41 of products and services. Also associated with these categories 41 is the name or logo of a sponsor 42 offering products or services in these categories. That sponsorship advertisement again generates income to the provider 25. The further printed code is accessible under one of these main advertising categories 41 and the user person must open one of these to find the code. Of course, most often many of these category icons will be opened before the code is located. Each icon category pertains to various products and services sectors such as travel, automobiles, food providers, hardware products, restaurants, etc.

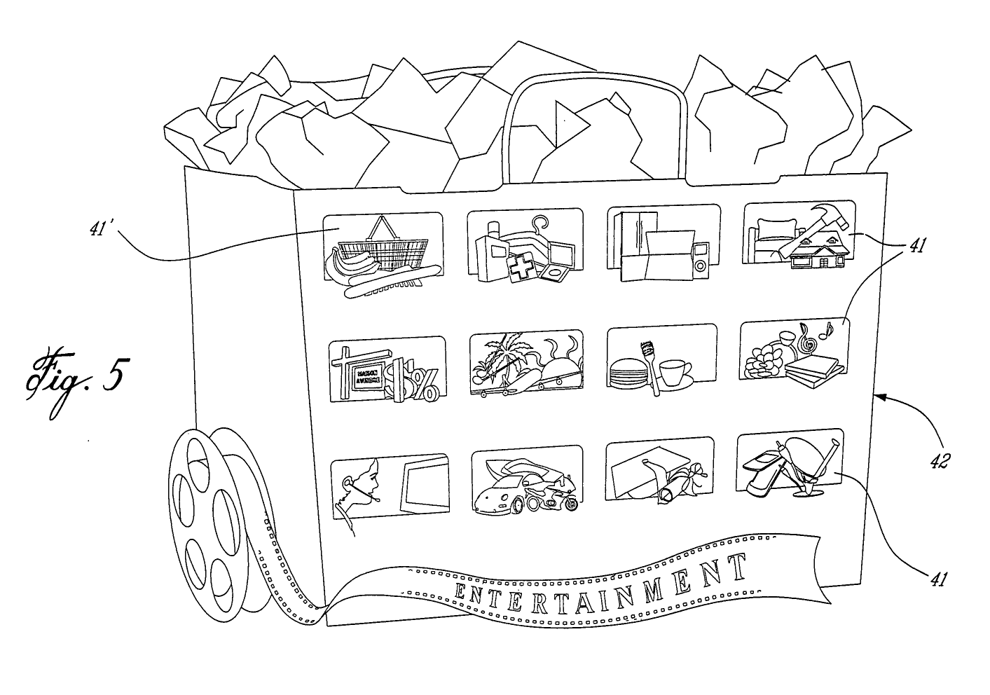

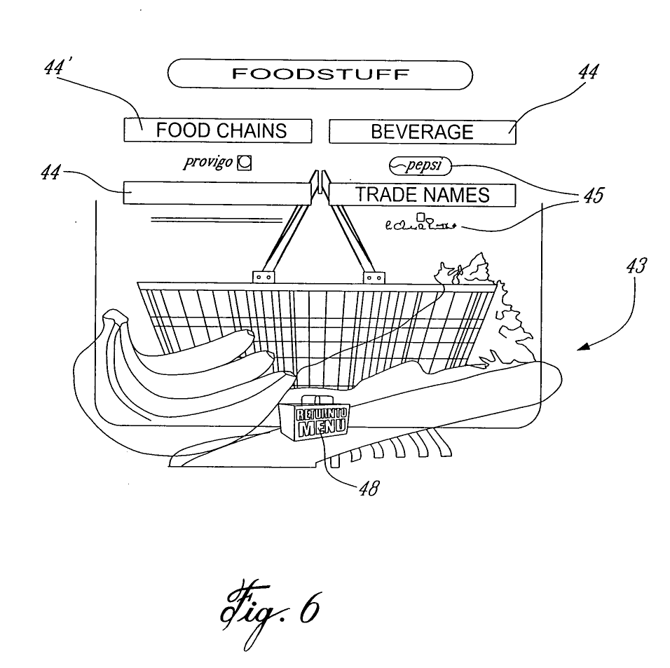

When one of the icons 41 in FIG. 5 is opened, they display a screen 43 as illustrated in FIG. 6. As hereinshwon the icon 41′ was opened and the screen now displays sub-advertising categories of the main category icon 41. The sub-advertising categories are depicted by reference numeral 44 and it provides the viewer with further icons for him to navigate into specific products or services of the previous categories. Again, these sub-category representations 44 may be associated with sponsorship logos such as shown at 45. When the category 44′, for example, is, viewed, a further window appears as shown at 46 in FIG. 7 and as hereinshown it provides access to the viewer to four different advertisers 47 for specific categories of products being sought by the viewer. A return-to-menu icon 48 is provided with the screen displays of FIGS. 6 and 7.

It is pointed out that these advertisements do not provide discount coupons but will display various products or services that are promoted at discounted prices.

It is also pointed out that the formatted CD or DVD also contains non-advertising material for the benefit of the recipient and this material can include short-clip animation material and films. The short-clip animation material would be segments of episodes of series, for example. Each of the segments is provided in associated ones of revised CDs, DVDs delivered on a periodic basis to the recipient in a particular postal code area. Such deliveries are continuously monitored and controlled by the provider 25. As an example of episodes it is conceivable that this can comprise a series of exercise programs, cooking programs, home construction and decoration series, gardening, health, horoscope, classified ads, and the like programs that can be segmented and which is beneficial for the private viewing of the recipient. This type of material also induces the recipient in visualizing the CD/DVDs that are mailed to him on a periodic basis particularly if the viewer is interested in one or more of these segmented programs. It is further pointed out that the contest or prize associated with the printed code on the front panel of the carrier package is provided in the form of products and services rendered by the advertisers. It is further pointed out that the main category icons or sub-category icons may comprise introductions which are animated by a real person or an animated person which is associated with the products and services. For example, the owner of a food product chain or pharmacy or repair shop can appear on the screen to introduce his products or services and this at a cost much inferior to the cost of having to appear on television through the TV media. It is also pointed out that when the initial display 40 appears on the screen, or before this initial display, there could be another display with icons representative of various languages that the recipient may select whereby to view the material in a specific language. For example, the CD/DVD can be formatted in English, French and Spanish and this would depend on the targeted geographical areas for the distribution of the disc.

One can appreciate that this method of distributing advertisement and formatting of the disc contents, to offer the products and services of participating advertisers, provides many advantages. One such advantage is that the advertisement is of high quality and can contain audio and live material. The advertisement can provide for the transmission of a large amount of material to be directed to a potential consumer. The advertisers are also provided with better visibility as this material can be personally selected to be visualized on a screen, which is usually much larger than any printed advertising material. The method also permits the targeting of consumers in designated postal code areas where there are preferred consumers, i.e., those that have the financial means to avail themselves of the products and services being offered. Accordingly, the advertising material provides for direct advertising. The advertisers are also associated with a medium that contributes to the green space and saves our forestry products.

Another advantage is that the CD/DVD disc is a carrier of information that can be consulted by all members of a family to visualize the advertiser's products or services or the non-advertising material as previously described. Another advantage of this method is that it can deliver the disc to all families in a designated postal code area without occupying much space in their mailbox, due to its packaging. A still further advantage of the manner in which the CD or DVD is formatted is that advertisers in different categories are provided exposure regardless if the user is accessing other categories more suitable to the viewer. It is a form of repetitive advertising as opposed to a targeted consumer receiving printed material, the majority of which is discarded and therefore no longer accessible to the targeted consumer. The product is also easy to use by the recipient simply by depressing the button “enter” on the controller of a DVD player or on the keypad of a computer keyboard. This advertising method captures the attention of the user and provides a better return on the investment of the advertisers. It also provides a benefit to the environment which is the concern of most people.

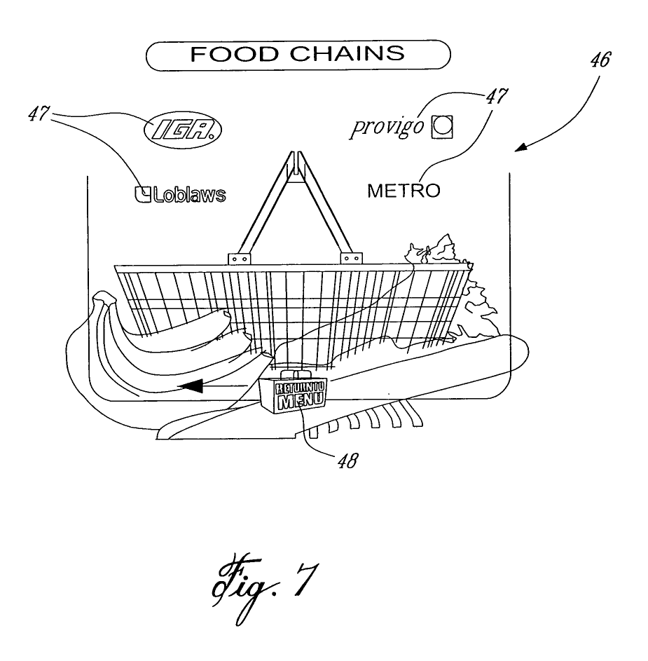

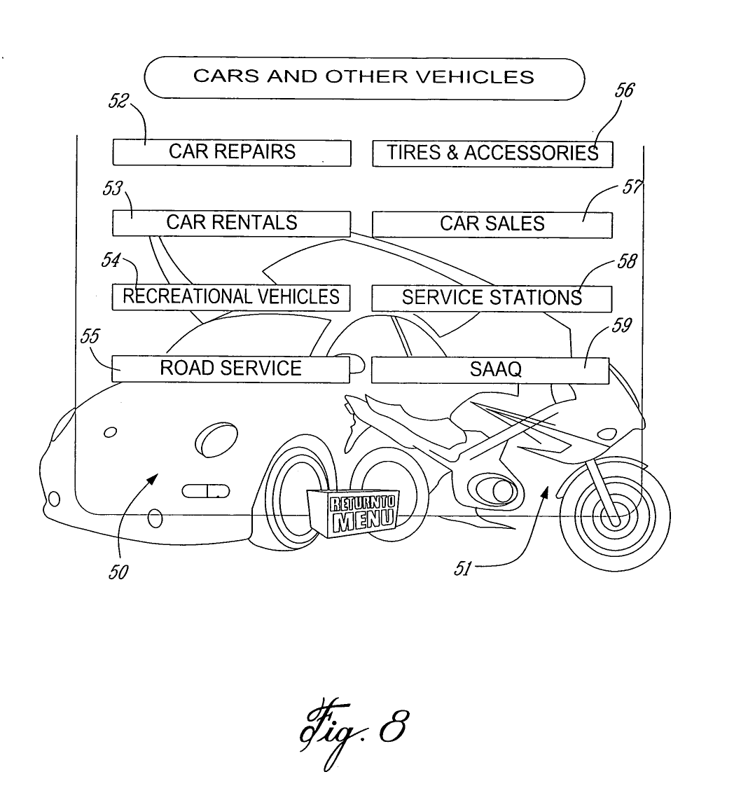

FIGS. 8 and 9 are representations of examples only of further main advertising categories. FIG. 8 is representative of categories associated with automobiles as depicted at 50 by a picture of an automobile or at 51 by a picture of a motorcycle and it has various categories navigatable by the user such as depicted at 52 for repairs, 53 for rentals, 54 for recreational vehicles, 55 for road assistance, 56 for tires and accessories, 57 for purchasing, 58 for service stations and at 59 for insurance providers. Accordingly, a user person is provided with most services associated with automobiles in an easy and quick method of accessing this associated information on a single screen display. FIG. 9 is a similar display illustrating another category, herein a travel category 60 and providing various services such as travel agencies 61, hotels 62, transporters 63, destinations 64, casinos 65, and tourist areas 66. These are examples only of categories.

It is within the ambit of the present invention to cover any obvious modifications of the preferred embodiment described herein, provided such modifications fall within the scope of the appended claims. For example, although the medium carrier herein-described is in the form of a CD or DVD disc, it is conceived that it could be in the form of a memory stick or other medium that can be delivered by the postal service.

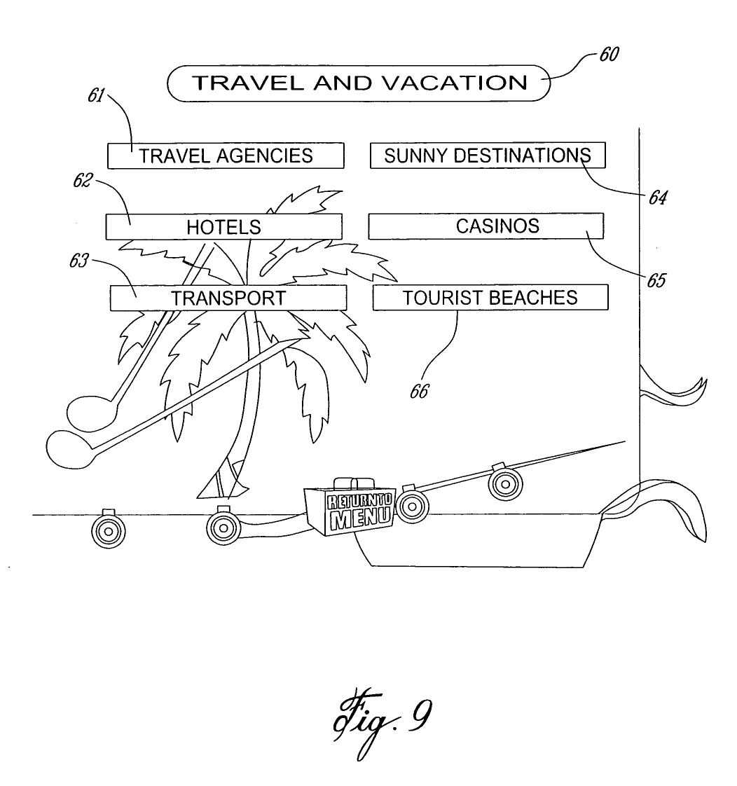

Referring now to FIG. 10, there is shown, generally at 70, another modification of the present invention wherein the advertising products and services of advertisers in the format as above-described can be accessed through the web. As hereinshown the provider, “GreenVision”, has a database 71 which is accessible by users 73 through an internet service provider or a mobile switching center 72. Accordingly, the method comprises the production of the media database 71 incorporating advertising formatted material in a predetermined navigational sequence, as previously described. The formatted material includes main advertising categories and sub-advertising categories as illustrated in FIGS. 5 and 6. A first personalized code is incorporated in the media database and visible when accessed by a particular user. The media database will also comprise non-advertising material and a further displayable code accessible at predetermined locations in the advertising material. If both codes match, then the user is provided a benefit. Once the user accesses the media database his IP address or telephone number permits the service provider to deliver revised versions of the media database through the web on a periodic basis.

The user accesses the web via various telecommunication devices and these can comprise desktop or laptop computers, hand-held communication devices, personal digital assistance (PDA), mobile phones, cable networks or portable media players (iPod), etc. The user can either download a template of the product (menu) from the website or the menu may be integrated in the telecommunication device as part of the device when purchased. The user navigates through the database using his telecommunication device which provides, for example, “shopping buttons” on his mobile phone or link to the media website from his desktop or laptop computer. The formatted database permits for the user to select a region where he wants to receive the information and may search the site by postal code or the distance from him, both his postal code and a distance, such as H1H 5C9, 5 km and less. On the other hand he may key in just the distance if he is using the internet via mobile phone as the system is able to determine where the mobile phone is. The site can also be searched by regions, for example the name of cities.

Once the user selects the desired region, he presses the “send” button, which initiates the communication process to the media database. This connection will permit three different things to happen: 1) it will establish a connection between the user and the database; 2) it will instruct GreenVision Media where the user desires to search; and 3) it will generate and issue the number that may be the winning number to the user person. The information on the desired region is sent to the service provider and transmitted to the user by a cellular connection, when the device is a mobile phone using wireless access, or an internet connection, when the device is other than a mobile phone, for example, a desktop computer which is not wireless.

The service provider can be a mobile switching center or an internet service provider, as above-mentioned. The service provider makes the link between the user and the database of GreenVision. The service provider sends the user's request to the media database and the transmission between them is permitted via the internet connection. The media database contains all the information that the user can request and this advertising information can be sorted by regions and sent to the user via the service provider.

When the user accesses the media database, he obtains a random number generated and issued by the database that will entitle him to win a prize. If his number matches the hidden number in one of the navigational icons such as icons 41 and 41′ illustrated in FIG. 5 on the downloaded or integrated menu, a benefit is provided to the user. A message will appear on the screen of the telecommunication device, such as a mobile phone and display a message such as “check inside the menu for a matching number in order to win”. After a few seconds, the menu appears displaying the categories such as illustrated in FIGS. 5 and 6 and the user selects a category and sub-category until he finds a hidden code. During this search the advertising material is visible to the user.

If the user, for example, has a cellular phone and is in communication with the media database, an image such as shown in FIG. 5 will appear. The user then selects a category such as the icon 41 by pressing an appropriate key on his cell phone. By doing so the display changes to an image of sub-categories such as shown in FIG. 6. The user then selects a sub-category such as the icons 44, 44′ of FIG. 6 and presses the key “send”. The service provider receives these codes and deciphers them to transmit the information to the user. The user is now able to view the grocery stores available in the region that he previously requested.

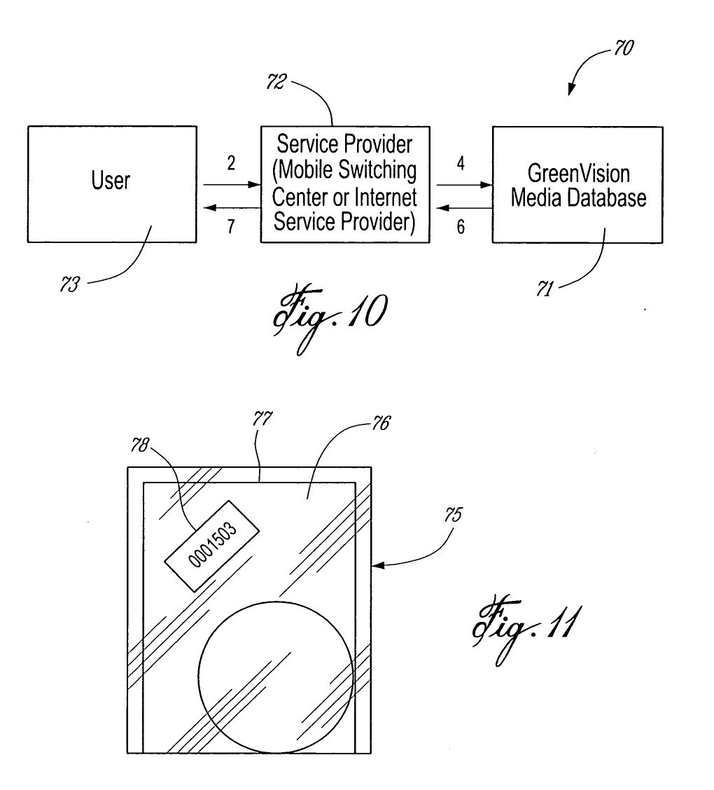

FIG. 11 shows another type of carrier package to deliver the CD/DVD 10. As hereinshown, the carrier package 75 is comprised of a sealed film pouch 76 containing a magazine 77 and/or other material and addressed to a subscriber. The subscriber is of course in a targeted geographical area and in a postal code region. If the package 75 is to be distributed through newsstands, these are also targeted areas which are pre-defined. The personalized printed code may be affixed to the CD/DVD 10 or simply on a sheet, such as sheet 78, inserted within the film pouch 76.

As can be appreciated, there are many forms of carrier packages to deliver the CD/DVD. It could also be attached to an envelope by a film or be distributed with newspapers by attaching it to a carrier sheet. These are examples only of delivery methods and others are obvious to persons skilled in the art and intended to be covered by the appended claims.

1. A method of advertising products and services of advertisers located in a targeted geographical area delineated by a postal code region and without the use of paper advertising material, said method comprising the steps of:
i) producing a machine readable medium carrier with advertising material formatted therein in a predetermined navigational sequence, said format including main advertising categories and sub-advertising categories;
ii) producing a carrier package for said medium carrier and providing a personalized printed code with said machine readable medium for a recipient of said carrier package;
iii) providing non-advertising material in said medium carrier for the benefit of said recipient and including a further printed code accessible in a predetermined location of said advertising material and if matched with said personalized printed code on said carrier package provides a benefit to said recipient;
iv) delivering said carrier package with said medium carrier to residents in one or more postal code areas by the postal service; and
v) delivering additional revised medium carriers on a periodic basis.

2. A method as claimed in claim 1 wherein said medium carrier is a CD/DVD disc, and wherein said printed code is provided on an outer surface of said package.

3. A method as claimed in claim 2 wherein there is further provided the step of returning used ones of said CD/DVD disc to a provider thereof for recycling by disposing said used ones of said CD/DVD disc in a postal box of the postal service.

4. A method as claimed in claim 2 wherein there is further provided the step of creating a foundation controlled by a provider of said CD/DVD disc to contribute a monetary value in the form of plants to enhance the environment in urban spaces and representative of the green space spared by the non-use of paper material to distribute advertisement.

5. A method as claimed in claim 2 wherein said carrier package is an envelope having the shape of a shopping bag symbolizing the material content of said CD/DVD disc.

6. A method as claimed in claim 2 wherein said personalized printed code on said carrier package is concealed under a scratch patch.

7. A method as claimed in claim 4 wherein said carrier package also includes printed matter on an outer face thereof relating to the activities of said foundation relating to the preservation of forest areas.

8. A method as claimed in claim 2 wherein said non-advertising material includes short clip animation material and films.

9. A method as claimed in claim 8 wherein said films include short segments of episodes of a series of episodes, each said segment being provided in associated one of said revised CD/DVD disc delivered on a periodic basis.

10. A method as claimed in claim 9 wherein said episode is one of a series of one of exercise programs, cooking programs, home construction and decoration series, gardening, health, horoscope, classified ads, and the like programs that can be segmented in episodes.

11. A method as claimed in claim 2 wherein said non-advertising material in said CD/DVD disc comprises a short clip animation relating to a contest or prize associated with said personalized printed code of said recipient, said contest or prize being associated with the products and services of said advertisers.

12. A method as claimed in claim 11 wherein said short clip animation is concealed under a main categories icon displayed on a shopping bag pictorial representation of said CD/DVD disc.

13. A method as claimed in claim 2 wherein said main categories include icons representative of each of said categories, a selection of said icons by a hand operable controller device causing a display on a screen of said reading machine of said sub-categories, said sub-categories providing to said recipient, which is a user person, the options to navigate into each said sub-categories to access at least one advertiser of said sub-categories.

14. A method as claimed in claim 13 wherein advertisers are displayed with said icons of said main or sub-categories.

15. A method as claimed in claim 13 wherein said controller device is one of a computer finger-operable controller or a DVD disc player controller associated with a television screen or computer screen.

16. A method as claimed in claim 13 wherein said main categories icons or said sub-categories icons are introduced by an animation of a real person or animated person associated with said products and services.

17. A method as claimed in claim 2 wherein said advertising material and non-advertising material formatted in said CD/DVD disc is provided in at least two languages selectable by said recipient by the use of a hand-operable controller device associated with a computer or DVD disc player of said recipient.

18. A method as claimed in claim 17 wherein said advertising material is displayed as static or animated images on a screen of said computer or DVD disc player.

19. A method as claimed in claim 1 wherein there is further provided a magnetic card in said carrier package, said card being associated with one or more of said advertisers and providing to said recipient a monetary credit when purchasing products or services of said advertisers.

20. A method as claimed in claim 3 wherein said carrier package or CD/DVD is provided with a printed return address for the return of said CD/DVD disc to said provider or a recycling entity for recycling.

21. A method of advertising products and services of advertisers located in a predetermined geographical area and without the use of paper advertising material, said method comprising the steps of:
i) producing a media database having advertising formatted material therein in a predetermined navigational sequence, said formatted material including main advertising categories and sub-advertising categories;
ii) incorporating in said media database a first personalized displayable code for a user accessing said media database;
iii) providing non-advertising material in said media database for the benefit of said user and including a second personalized displayable code accessible at a predetermined location in said advertising material and if matched with said first personalized displayable code provides a benefit to said user; and
iv) providing to said users revised versions of said media database on a periodic basis.

22. A method as claimed in claim 21 wherein said media database is accessible through an internet connection.

23. A method as claimed in claim 22 wherein said user is connected to said media database via one of an internet service provider or a mobile switching center.

24. A method as claimed in claim 23 wherein said user accesses said media database by one of a desktop or laptop computer, a mobile phone, a hand-held communication device or portable media players (iPod).
